(19) United States
(12) Patent Application Publication
(10) Pub. No.: US 2018/0166733 A1
(43) Pub. Date: Jun. 14, 2018

(54) FUEL CELL SYSTEM

(71) Applicant: TOYOTA JIDOSHA KABUSHIKI KAISHA, Toyota-shi (JP)

(72) Inventors: Koichi KAMINO, Aichi-gun (JP); Nobutaka TESHIMA, Toyota-shi (JP)

(73) Assignee: TOYOTA JIDOSHA KABUSHIKI KAISHA, Toyota-shi (JP)

(21) Appl. No.: 15/819,683

(22) Filed: Nov. 21, 2017

(30) Foreign Application Priority Data
Dec. 12, 2016 (JP) 2016-240083

(51) Int. Cl. H01M 8/2484; H01M 8/04119

(52) U.S. Cl. CPC H01M 8/2484; H01M 8/04156

(57) ABSTRACT

A fuel cell system includes a fuel cell stack including a hydrogen supply port into which hydrogen flows and a hydrogen discharge port from which hydrogen off-gas is discharged; a hydrogen circulation flow path connected to the hydrogen supply port and the hydrogen discharge port; and a circulation system auxiliary mechanism that is provided in the hydrogen circulation flow path and includes a hydrogen inlet into which the hydrogen off-gas flows and a hydrogen outlet from which the hydrogen off-gas flows. At least one of a positional relationship in which the hydrogen outlet is at a position below the hydrogen supply port in the direction of gravity and a positional relationship in which the hydrogen inlet is at a position below the hydrogen discharge port in the direction of gravity is satisfied.

The disclosure of Japanese Patent Application No. 2016240083 filed on Dec. 12, 2016 including the specification, drawings and abstract is incorporated herein by reference in its entirety.

### BACKGROUND

### 1. Technical Field

The present disclosure relates to a fuel cell system.

### 2. Description of Related Art

As a fuel cell system, a fuel cell system in which a hydrogen circulation system flow path through which hydrogen off gas discharged from a fuel cell stack is resupplied into the fuel cell stack is provided with a circulation system auxiliary mechanism in order to effectively use hydrogen gas is known. The circulation system auxiliary mechanism includes, for example, a hydrogen pump or a vapor-liquid separator as described in Japanese Unexamined Patent Application Publication No. 2008-16402 (JP 2008-16402 A).

### SUMMARY

Due to the positional relationship between a hydrogen inlet and a hydrogen outlet of the circulation system auxiliary mechanism and a hydrogen discharge port and a hydrogen supply port of the fuel cell stack, there may be cases where produced water stays in a hydrogen circulation flow path and blocks the hydrogen circulation flow path, or the produced water flows backward into the fuel cell stack from the circulation system auxiliary mechanism. There is a possibility that the produced water that stays or flows backward causes the degradation in power generation capacity and freezing. Therefore, a technique for suppressing the hackflow or staying of the produced water is desirable.

An aspect relates to a fuel cell system including: a fuel cell stack including a hydrogen supply port into which hydrogen flows and a hydrogen discharge port from which hydrogen off-gas is discharged; a hydrogen circulation flow path connected to the hydrogen supply port and the hydrogen discharge port; and a circulation system auxiliary mechanism that is provided in the hydrogen circulation flow path and includes a hydrogen inlet into which the hydrogen off gas flows and a hydrogen outlet from which the hydrogen off-gas flows. At least one of a positional relationship in which the hydrogen outlet is at a position below the hydrogen supply port in the direction of gravity and a positional relationship in which the hydrogen inlet is at a position below the hydrogen. discharge port in the direction of gravity is satisfied. According to the aspect, since the hydrogen outlet of the circulation system auxiliary mechanism, the hydrogen supply port of the fuel cell stack, the hydrogen inlet of the circulation system auxiliary mechanism, and the hydrogen discharge port of the fuel cell stack are disposed such that at least one of the positional relationship in which the hydrogen outlet of the circulation system auxiliary mechanism is at a position below the hydrogen supply port of the fuel cell stack and the positional relationship in which the hydrogen inlet of the circulation system auxiliary mechanism is at a position below the hydrogen discharge port of the fuel cell stack is satisfied, the backflow of water from the circulation system auxiliary mechanism to the fuel cell stack or blocking of the hydrogen circulation flow path due to the water staying in the hydrogen circulation flow path can be suppressed.

In the fuel cell system according to the aspect, the circulation system auxiliary mechanism may be disposed below the fuel cell stack.

In the fuel cell system according to the aspect, the circulation system auxiliary mechanism may include a hydrogen pump configured to pump the hydrogen off-gas flowing from the hydrogen discharge port to the hydrogen supply port, and a vapor-liquid separator configured to separate water from the hydrogen off-gas flowing from the hydrogen discharge port. The hydrogen pump may be disposed below the fuel cell stack, and the vapor-liquid separator may be disposed below the hydrogen pump.

In the fuel cell system according to the aspect, the hydrogen pump may be disposed above the hydrogen discharge port and below the hydrogen supply port.

In the fuel cell system according to the aspect, the vapor-liquid separator may have a hydrogen outlet disposed above the hydrogen inlet.

In the fuel cell system according to the aspect, the hydrogen pump may have a hydrogen inlet disposed below the hydrogen outlet.

In the fuel cell system according to the aspect, the circulation system auxiliary mechanism may include a hydrogen pump configured to pump the hydrogen off-gas flowing from the hydrogen discharge port to the hydrogen supply port, and the hydrogen outlet of the hydrogen pump may be disposed below the hydrogen supply port in the direction of gravity. According to the aspect, the backflow of the water from the hydrogen pump to the fuel cell stack can be suppressed.

In the fuel cell system according to the aspect, the circulation system auxiliary mechanism may include the vapor-liquid separator configured to separate the water from the hydrogen off-gas flowing from the hydrogen discharge port, and the hydrogen inlet of the vapor-liquid separator may be disposed below the hydrogen discharge port in the direction of gravity. According to the aspect, the backflow of the water from the vapor-liquid separator to the fuel cell stack can be suppressed.

According to the aspect, the fuel cell system can be realized in various forms. For example, the fuel cell system can be realized in the form of a power generation device provided with the fuel cell system, or a vehicle provided with the fuel cell system.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is an explanatory view illustrating a schematic configuration of a fuel cell system;

FIG. 2 is an explanatory view illustrating the positional relationship between a fuel cell stack and a circulation system auxiliary mechanism; and

FIG. 3 is an explanatory view illustrating a schematic configuration of a fuel cell vehicle.

### DETAILED DESCRIPTION OF EMBODIMENTS

### A. FIRST EMBODIMENT

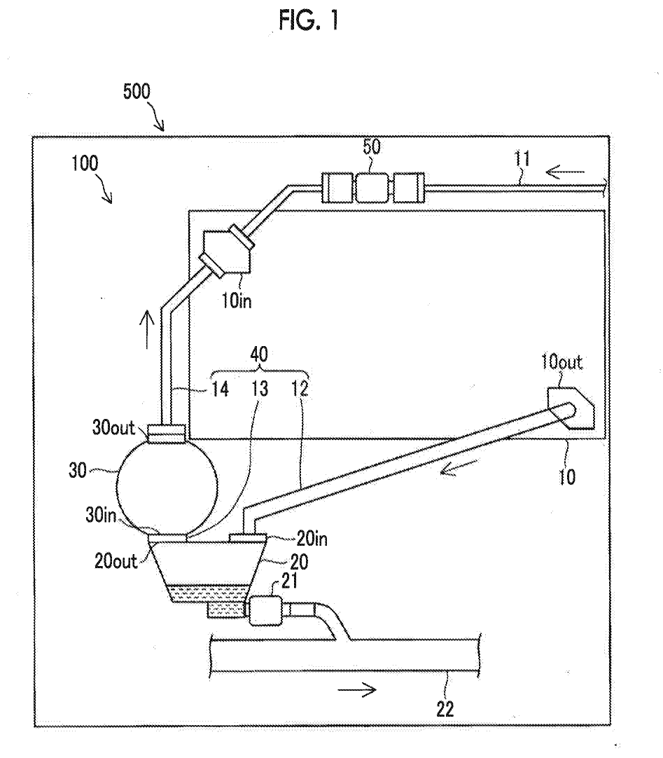

FIG. 1 is an explanatory view illustrating a schematic configuration of a fuel cell system 100 according to an embodiment. The fuel cell system 100 includes a fuel cell stack 10, a vapor-liquid separator 20, a hydrogen pump 30, and a hydrogen circulation flow path 40. In the embodiment, the fuel cell system 100 is mounted in a fuel cell vehicle 500. In the fuel cell vehicle 500, the fuel cell stack 10 is mounted as an electric power source, and a tire (not illustrated) is driven by driving a motor (not illustrated) as a driving power source.

The fuel cell stack 10 is a solid polymer electrolyte fuel cell, is supplied with hydrogen gas via an injector 50 from a hydrogen supply pipe 11, and is supplied with air from an air supply system (not illustrated) to generate power. The injector 50 is an electromagnetic drive type on-off valve in which a valve body is electromagnetically driven according to a driving cycle or a valve opening time set by a control device (not illustrated). The fuel cell stack 10 includes a hydrogen supply port 10 in into which hydrogen flows from the hydrogen supply pipe 11 and a hydrogen discharge port 10 out from which hydrogen off-gas is discharged to a first hydrogen pipe 12.

A flow path that is connected to the hydrogen supply port 10 in and the hydrogen discharge port 10 out and is constituted of the first hydrogen pipe 12, a second hydrogen pipe 13, and a third hydrogen pipe 14 is referred to as a hydrogen circulation flow path 40. The hydrogen circulation flow path 40 is a flow path used to circulate the hydrogen off-gas from the fuel cell stack 10 into the fuel cell stack 10. The hydrogen circulation flow path 40 is provided with the vapor-liquid separator 20 and the hydrogen pump 30 which are mechanisms for assisting the circulation of hydrogen, as circulation system auxiliary mechanisms.

The first hydrogen pipe 12 is a pipe that connects the hydrogen discharge port 10 out of the fuel cell stack 10 to the vapor-liquid separator 20. The first hydrogen pipe 12 introduces the hydrogen off-gas including hydrogen gas that was not used in a power generation reaction and impurities such as nitrogen gas and produced water into the vapor-liquid separator 20.

The vapor-liquid separator 20 is connected between the first hydrogen pipe 12 and the second hydrogen pipe 13 of the hydrogen circulation flow path 40. The vapor-liquid separator 20 includes a vapor-liquid inlet 20 in to which the first hydrogen pipe 12 is connected and into which the hydrogen off-gas flows, and a vapor-liquid outlet 20 out to which the second hydrogen pipe 13 is connected and from which hydrogen is discharged. The vapor-liquid separator 20 separates the produced water from the hydrogen off-gas flowing from the hydrogen discharge port 10 out of the fuel cell stack 10 and stores the produced water therein. An exhaust and drain valve 21 is provided under the vapor-liquid separator 20.

The exhaust and drain valve 21 is a solenoid valve that drains the produced water stored in the vapor-liquid separator 20 and emits the hydrogen off-gas in the vapor-liquid separator 20. The exhaust and drain valve 21 is normally closed during an operation of the fuel cell system 100 and is opened or closed according to a control signal from the control device (not illustrated). In the embodiment, the exhaust and drain valve 21 is connected to a hydrogen off-gas pipe 22, and the produced water and the hydrogen off-gas discharged by the exhaust and drain valve 21 are discharged to the outside through the hydrogen off-gas pipe 22.

The second hydrogen pipe 13 is a pipe that connects the vapor-liquid outlet 20 out of the vapor-liquid separator 20 to the hydrogen pump 30. The second hydrogen pipe 13 introduces the hydrogen off-gas from which the produced water is separated by the vapor-liquid separator 20, into the hydrogen pump 30.

The hydrogen pump 30 is connected between the second hydrogen pipe 13 and the third hydrogen pipe 14 of the hydrogen circulation flow path 40. The hydrogen pump 30 is driven by a control signal from the control device (not illustrated). The hydrogen pump 30 is a pump that pumps the hydrogen off-gas flowing from the hydrogen discharge port 10 out of the fuel cell stack 10 into the hydrogen supply port 10 in. In the embodiment, the hydrogen pump 30 pumps the hydrogen off-gas from which the produced water is separated by the vapor-liquid separator 20, into the hydrogen supply port 10 in through the third hydrogen pipe 14. The hydrogen pump 30 includes a pump inlet 30 in into which the hydrogen off-gas flows from the second hydrogen pipe 13 and a pump outlet 30 out from which the hydrogen off-gas flows into the third hydrogen pipe 14.

The third hydrogen pipe 14 is a pipe that connects the pump outlet 30 out of the hydrogen pump 30 to the hydrogen supply port 10 in of the fuel cell stack 10. The third hydrogen pipe 14 introduces the hydrogen off-gas pumped by the hydrogen pump 30 into the fuel cell stack 10. In the embodiment, the hydrogen off-gas discharged from the fuel cell stack 10 is circulated by the circulation system auxiliary mechanisms (the vapor-liquid separator 20 and the hydrogen pump 30) and the hydrogen circulation flow path 40 and is resupplied to the fuel cell stack 10, thereby improving the use efficiency of hydrogen.

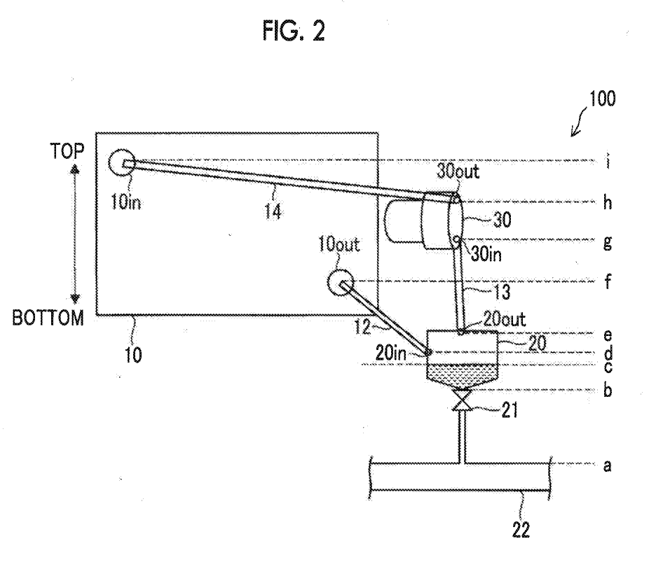

FIG. 2 is an explanatory view illustrating the positional relationship between the fuel cell stack 10 and the circulation system auxiliary mechanisms. The lower side in FIG. 2 corresponds to the lower side in the direction of gravity. Positions a to i represent positions in the direction of gravity. The position a of the hydrogen off-gas pipe 22 is lower than the position b of the exhaust and drain valve 21, and the position b is lower than the position c of the liquid surface of the produced water stored in the vapor-liquid separator 20. The position d of the vapor-liquid inlet 20 in and the position e of the vapor-liquid outlet 20 out are disposed above the upper limit of the position c of the liquid surface so as not to cause the stored produced water to stay and flow backward.

The position e is lower than the position f of the hydrogen discharge port 10 out of the fuel cell stack 10, and the position f is lower than the position g of the pump inlet 30 in. The position g is lower than the position h of the pump outlet 30 out, and the position h is lower than the position i of the hydrogen supply port 10 in. In addition, the first hydrogen pipe 12, the second hydrogen pipe 13, and the third hydrogen pipe 14 are disposed vertically or inclined downward from the hydrogen discharge port 10 out to the vapor-liquid inlet 20 in, from the pump inlet 30 in to the vapor-liquid outlet 20 out, and from the hydrogen supply port 10 in to the pump outlet 30 out, respectively. Furthermore, the first hydrogen pipe 12, the second hydrogen pipe 13, and the third hydrogen pipe 14 are formed so as not to have points positioned below the vapor-liquid inlet 20 in, the vapor-liquid outlet 20 out, and the pump outlet 30 out, respectively.

In the embodiment described above, the pump outlet 30 out of the hydrogen pump 30 as a hydrogen outlet of the circulation system auxiliary mechanism is disposed below the hydrogen supply port 10 in of the fuel cell stack 10, and the vapor-liquid inlet 20 in of the vapor-liquid separator 20 as a hydrogen inlet of the circulation system auxiliary mechanism is disposed below the hydrogen discharge port 10 out of the fuel cell stack 10. Therefore, the backflow of the produced water from the circulation system auxiliary mechanisms to the fuel cell stack 10 or blocking of the hydrogen circulation flow path 40 due to the produced water staying in the hydrogen circulation flow path 40 can be suppressed.

In addition, in the fuel cell system 100 of the embodiment, since the pump outlet 30 out as the hydrogen outlet of the hydrogen pump 30 is disposed below the hydrogen supply port 10 in of the fuel cell stack 10, the backflow of the produced water from the hydrogen pump 30 to the fuel cell stack 10 can be suppressed. In addition, since the vapor-liquid inlet 20 in as the hydrogen inlet of the vapor-liquid separator 20 is disposed below the hydrogen discharge port 10 out of the fuel cell stack 10, the backflow of the produced water from the vapor-liquid separator 20 to the fuel cell stack 10 can be suppressed.

In addition, in the embodiment, at least one of the positional relationship in which the position h is lower than the position i, that is, the pump outlet 30 out as the hydrogen outlet of the circulation system auxiliary mechanism is positioned below the hydrogen supply port 10 in, and the positional relationship in which the position d is lower than the position f, that is, the vapor-liquid inlet 20 in as the hydrogen inlet of the circulation system auxiliary mechanism is positioned below the hydrogen discharge port 10 out may be satisfied. When any one of the positional relationships is satisfied, at least one of the backflow of the produced water from the hydrogen pump 30 to the fuel cell stack 10 and the backflow of the produced water from the vapor-liquid separator 20 to the fuel cell stack 10 can he suppressed.

### B. SECOND EMBODIMENT

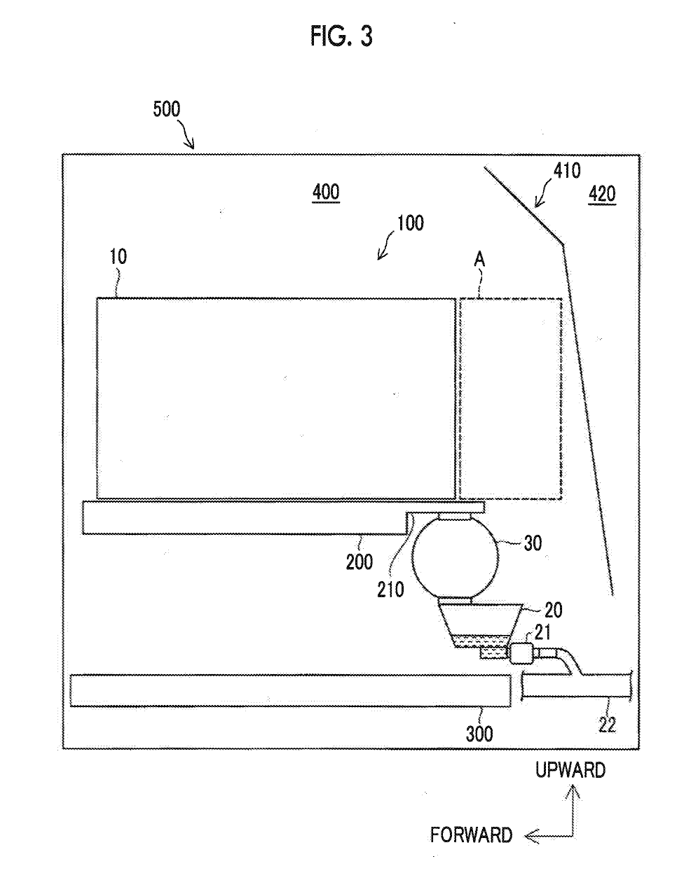

FIG. 3 is an explanatory view illustrating a schematic configuration of a fuel cell vehicle 500. FIG. 3 illustrates a front room 400 of the fuel cell vehicle 500. In FIG. 3, the left side corresponds to the front side of the fuel cell vehicle 500, and the lower side corresponds to the lower side in the direction of gravity. The fuel cell vehicle 500 includes the fuel cell system 100, a stack frame 200, and a suspension member 300. In the fuel cell vehicle 500, the front room 400 and a vehicle cabin 420 are separated by a dash panel 410.

The fuel cell stack 10 is mounted on the stack frame 200. The stack frame 200 is a metal member that supports the fuel cell stack 10 from below. The lower portion of the stack frame 200 is fixed to the suspension member 300. The suspension member 300 is a frame member that supports suspension links.

In the embodiment, the vapor-liquid separator 20, the exhaust and drain valve 21, and the hydrogen pump 30 are disposed between the stack frame 200 and the suspension member 300 not in a space A between the fuel cell stack 10 and the dash panel 410. The lower portion of the stack frame 200 provided with a cutout 210 where such components are disposed. Therefore, in the embodiment, as the positional relationship between the fuel cell stack 10 and the circulation system auxiliary mechanisms, the hydrogen pump 30 is disposed below the fuel cell stack 10, and the vapor-liquid separator 20 is disposed below the hydrogen pump 30. Therefore, the pump outlet 30 out as the hydrogen outlet of the hydrogen pump 30 is disposed below the hydrogen supply port 10 in of the fuel cell stack 10, and the vapor-liquid inlet 20 in as the hydrogen inlet of the vapor-liquid separator 20 is disposed below the hydrogen discharge port 10 out of the fuel cell stack 10. As a result, even in the embodiment, as in the first embodiment, the backflow of the produced water from the circulation system auxiliary mechanisms to the fuel cell stack 10 can be suppressed.

In addition, with the fuel cell vehicle 500 of the embodiment, since the vapor-liquid separator 20 and the hydrogen pump 30 as the circulation system auxiliary mechanisms are installed below the fuel cell stack 10, the centroid of the fuel cell vehicle 500 is lowered, resulting in the improvement of the steering stability of the fuel cell vehicle 500.

Furthermore, in the embodiment, the vapor-liquid separator 20 and the hydrogen pump 30 which are components with relatively high stiffness are disposed below the fuel cell stack 10 not in the space A between the fuel cell stack 10 and the dash panel 410. Therefore, even in a case of a frontal collision of the fuel cell vehicle 500, the movement amount of the fuel cell stack 10 in the front-rear direction of the fuel cell vehicle 500 is ensured, and a load applied to the fuel cell stack 10 can be reduced. In addition, the pressing of the vapor-liquid separator 20 and the hydrogen pump 30 against the dash panel 410 and the intrusion thereof into the vehicle cabin can be suppressed.

### C. MODIFICATION EXAMPLE

### First Modification Example

In the embodiment, the fuel cell system 100 includes the vapor-liquid separator 20 and the hydrogen pump 30 as the circulation system auxiliary mechanisms. Contrary to this, the fuel cell system 100 may also include any one of the vapor-liquid separator 20 and the hydrogen pump 30 as the circulation system auxiliary mechanism. Alternatively, the fuel cell system 100 may include another mechanism that assists the circulation of hydrogen as the circulation system auxiliary mechanism instead of the vapor-liquid separator 20 and the hydrogen pump 30.

### Second Modification Example

In the first embodiment, the hydrogen pump 30 is disposed above the hydrogen discharge port 10 out and below the hydrogen supply port 10 in. Contrary to this, the hydrogen pump 30 may also be disposed above the hydrogen supply port 10 in. However, the centroid of the vehicle is raised, and thus the steering stability of the fuel cell vehicle 500 is reduced. Therefore, it is preferable that the hydrogen pump 30 is disposed below the hydrogen supply port 10 in.

### Third Modification Example

In the embodiment, in the vapor-liquid separator 20, the vapor-liquid inlet 20 in is disposed below the vapor-liquid outlet 20 out. Contrary to this, the vapor-liquid separator 20 may also be disposed to have a positional relationship in which the vapor-liquid inlet 20 in is disposed above or at the same height as the vapor-liquid outlet 20 out.

### Fourth Modification Example

In the embodiment, in the hydrogen pump 30, the pump inlet 30 in is disposed below the pump outlet 30 out. Contrary to this, the hydrogen pump 30 may also be disposed to have a positional relationship in which the pump inlet 30 in is disposed above or at the same height as the pump outlet 30 out.

The disclosure is not limited to the embodiments or the modification examples described above, and can be realized in various configurations without departing from the gist of the disclosure. For example, technical features in the embodiments and the modification examples corresponding to the technical features in each of the aspects described in “SUMMARY” can be appropriately replaced or combined in order to solve the problems described above, or accomplish a portion or the entirety of the effects described above. In addition, unless the technical features described above are described as indispensable in this specification, the technical features can be appropriately deleted,

What is claimed is:

1. A fuel cell system comprising:
a fuel cell stack including a hydrogen supply port into which hydrogen flows and a hydrogen discharge port from which hydrogen off-gas is discharged;
a hydrogen circulation flow path connected to the hydrogen supply port and the hydrogen discharge port; and
a circulation system auxiliary mechanism that is provided in the hydrogen circulation flow path and includes a hydrogen inlet into which the hydrogen off-gas flows and a hydrogen outlet from which the hydrogen off-gas flows,
wherein at least one of (i) a positional relationship in which the hydrogen outlet is below the hydrogen supply port in a direction of gravity and (ii) a positional relationship in which the hydrogen inlet is below the hydrogen discharge port in the direction of gravity is satisfied.

2. The fuel cell system according to claim 1, wherein the circulation system auxiliary mechanism is disposed below the fuel cell stack.

3. The fuel cell system according to claim I, wherein:
the circulation system auxiliary mechanism includes
a hydrogen pump configured to pump the hydrogen off-gas flowing from the hydrogen discharge port to the hydrogen supply port, and
a vapor-liquid separator configured to separate water from the hydrogen off-gas flowing from the hydrogen discharge port;
the hydrogen pump is disposed below the fuel cell stack; and
the vapor-liquid separator is disposed below the hydrogen pump.

4. The fuel cell system according to claim 3, wherein the hydrogen pump is disposed above the hydrogen discharge port and below the hydrogen supply port.

5. The fuel cell system according to claim 3, wherein the vapor-liquid separator has a hydrogen outlet of the vapor-liquid separator disposed above the hydrogen inlet.

6. The fuel cell system according to claim 3, wherein the hydrogen pump has a hydrogen inlet of the hydrogen inlet disposed below the hydrogen outlet.

7. The fuel cell system according to claim 1, wherein:
the circulation system auxiliary mechanism includes a hydrogen pump configured to pump the hydrogen off-gas flowing from the hydrogen discharge port to the hydrogen supply port; and
the hydrogen outlet of the hydrogen pump is disposed below the hydrogen supply port in the direction of gravity.

8. The fuel cell system according to claim 1, wherein:
the circulation system auxiliary mechanism includes the vapor-liquid separator configured to separate water from the hydrogen off-gas flowing from the hydrogen discharge port; and
the hydrogen inlet of the vapor-liquid separator is disposed below the hydrogen discharge port in the direction of gravity.
